(19) United States
(12) Patent Application Publication
(10) Pub. No.: US 2009/0139236 A1
(43) Pub. Date: Jun. 4, 2009

(54) PREMIXING DEVICE FOR ENHANCED FLAMEHOLDING AND FLASH BACK RESISTANCE

(75) Inventors: Ertan Yilmaz, Albany, NY (US); Balachandar Varatharajan, Clifton Park, NY (US); Gilbert Otto Kraemer, Greer, SC (US); Benjamin Paul Lacy, Greer, SC (US); Baifang Zuo, Simpsonville, SC (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: GENERAL ELECTRIC COMPANY, SCHENECTADY, NY (US)

(21) Appl. No.: 11/946,892

(22) Filed: Nov. 29, 2007

(51) Int. Cl. F23R 3/42; F02C 1/00

(52) U.S. Cl. 60/737; 60/748

(57) ABSTRACT

A premixing device is provided. The premixing device includes a fuel inlet configured to introduce a fuel within the premixing device and an air inlet configured to introduce air within the premixing device. The premixing device also includes a plurality of swirler vanes configured to provide a swirl movement to the fuel and/or air to facilitate mixing of the fuel and air to form a gaseous pre-mix, wherein a shape of each of the plurality of swirler vanes is selected to control an axial velocity profile of the fuel and/or air within the premixing device.

### STATEMENT REGARDING FEDERALLY SPONSORED RESEARCH & DEVELOPMENT

This invention was made with Government support under contract number DE-FC26-05NT42643 awarded by the U.S. Department of Energy. The Government has certain rights in the invention.

### BACKGROUND

The invention relates generally to premixing devices, and more particularly to, a premixing device for enhanced flameholding and flash back resistance.

Various types of combustors are known and are in use in systems such as in combined cycle power plants. Typically, the combustors for such systems are designed to minimize emissions such as NOₓ and carbon monoxide emissions. In most natural gas fired systems, the combustors are operated using lean premixed flames. In these systems fuel is mixed with air using a premixing device that is upstream of a combustion zone for creating a premixed flame at lean conditions to reduce emissions from the combustor.

Typically, it is difficult to achieve adequate flameholding margins in such premixing devices. In some combustors, the average velocity of fuel-air mixture is increased within a mixing region of the premixing device for enhancing the flameholding margins in such devices. However, this results in a relatively high pressure drop across the combustor thereby decreasing the combustor efficiency.

Accordingly, there is a need for a premixing device that enhances the flameholding margins of the combustor while maintaining an acceptable pressure drop across the combustor. Furthermore, it is be desirable to provide a premixing device that enhances the flash back resistance of the combustor and can be used for a wide variety of fuels.

### BRIEF DESCRIPTION

Briefly, according to one embodiment, a premixing device is provided. The premixing device includes a fuel inlet configured to introduce a fuel within the premixing device and an air inlet configured to introduce air within the premixing device. The premixing device also includes a plurality of swirler vanes configured to provide a swirl movement to the fuel and/or air to facilitate mixing of the fuel and air to form a gaseous pre-mix, wherein a shape of each of the plurality of swirler vanes is selected to control an axial velocity profile of the fuel and/or air within the premixing device.

In another embodiment, a combustor is provided. The combustor includes a premixing device configured to mix fuel and air to form a gaseous pre-mix. The premixing device includes a plurality of swirler vanes configured to provide a swirl movement to the fuel and/or air to facilitate mixing of the fuel and air, wherein a shape of each of the plurality of swirler vanes is selected to control an axial velocity profile of the fuel and/or air within the premixing device. The combustor also includes a combustion chamber configured to combust the gaseous pre-mix.

In another embodiment, a method of operating a combustor is provided. The method includes introducing fuel and air within a premixing device and controlling an axial velocity profile of the fuel and/or air within the premixing device to form a gaseous pre-mix. The method also includes combusting the gaseous pre-mix in a combustion chamber.

### DRAWINGS

These and other features, aspects, and advantages of the present invention will become better understood when the following detailed description is read with reference to the accompanying drawings in which like characters represent like parts throughout the drawings, wherein:

FIG. 1 is a diagrammatical illustration of a gas turbine system in accordance with aspects of the present technique.

FIG. 2 is a diagrammatical illustration of a combustor having a premixing device employed in the gas turbine system of FIG. 1 in accordance with aspects of the present technique.

FIG. 3 is a diagrammatical illustration of an exemplary configuration of the premixing device having swirler vanes employed in the combustor of FIG. 2 in accordance with aspects of the present technique.

FIG. 4 is a diagrammatical illustration of an exemplary configuration of the swirler vanes of FIG. 3 in accordance with aspects of the present technique.

FIG. 5 is a diagrammatical illustration of another exemplary configuration of the swirler vanes of FIG. 4 in accordance with aspects of the present technique.

FIG. 6 is a diagrammatical illustration of an exemplary axial velocity profile across the annulus at the end of the centerbody of the premixing device employed in the combustor of FIG. 2 in accordance with aspects of the present technique.

FIG. 7 is a graphical representation of exemplary results for fuel/air unmixedness for a premixing device with a conventional swirler.

FIG. 8 is a graphical representation of exemplary results for fuel/air unmixedness for a premixing device with a low swirl.

FIG. 9 is a graphical representation of exemplary results for fuel/air unmixedness for the premixing device of FIG. 4.

### DETAILED DESCRIPTION

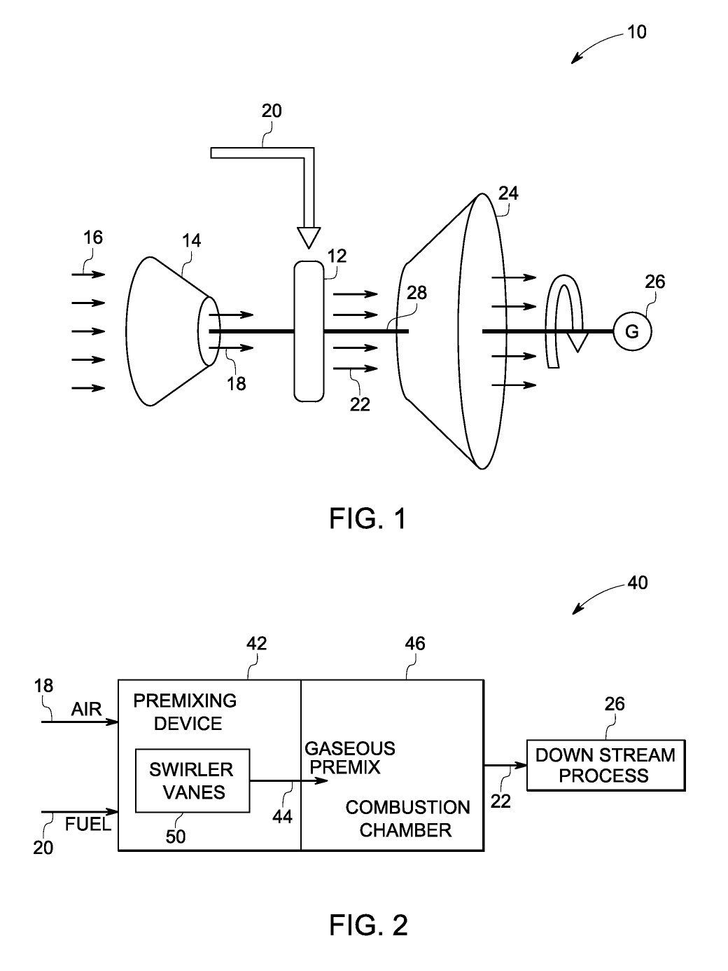

As discussed in detail below, embodiments of the present technique function to enhance flameholding margin and flash back resistance in combustors such as in combustors employed in gas turbines. In particular, the present technique includes tailoring of velocity profile of fuel and air within a premixing device for achieving enhanced flameholding and flash back resistance. Turning now to the drawings and referring first to FIG. 1 a gas turbine 10 having a combustor 12 is illustrated. The gas turbine 10 includes a compressor 14 configured to compress ambient air 16. The combustor 12 is in flow communication with the compressor 14 and is configured to receive compressed air 18 from the compressor 14 and to combust a fuel stream 20 to generate a combustor exit gas stream 22. In addition, the gas turbine 10 includes a turbine 24 located downstream of the combustor 12. The turbine 24 is configured to expand the combustor exit gas stream 22 to drive an external load such as a generator 26. In the illustrated embodiment, the compressor 14 is driven by the power generated by the turbine 24 via a shaft 28.

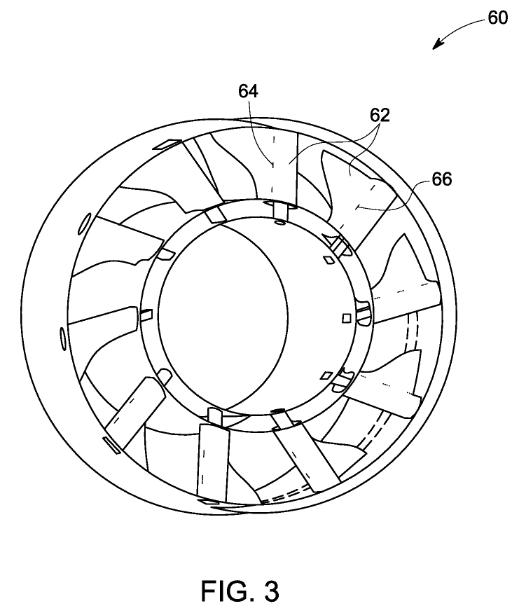

The combustor 12 employs a premixing device configured to control the axial velocity profile of the fuel and/or air for enhancing the flameholding and flash back resistance of the combustor 12. FIG. 2 is a diagrammatical illustration of an exemplary configuration 40 of the combustor 12 having a premixing device 42 employed in the gas turbine system 10 of FIG. 1 in accordance with aspects of the present technique. As illustrated, the combustor 40 includes the premixing device 42 configured to mix fuel 20 and air 18 to form a gaseous pre-mix 44. Further, the combustor 40 includes a combustion chamber 46 configured to combust the gaseous pre-mix 44 to form the combustor exit gas stream 22. Further, the combustor exit gas stream 22 is directed to a downstream process 48 such as to the turbine 24 (see FIG. 1) for driving the external load 26 (see FIG. 1).

In this exemplary embodiment, the premixing device 42 includes a plurality of swirler vanes 50 configured to provide a swirl movement to the fuel 20 and/or air 18 to facilitate mixing of the fuel 20 and air 18. Further, a shape of the each of the plurality of swirler vanes 50 is selected to control an axial velocity profile of the fuel 20 and/or air 18 within the premixing device 42. In certain embodiments, the shape of each of the plurality of swirler vanes 50 is selected to control a circumferential velocity profile of the fuel 20 and/or air 18 within the premixing device 42. FIG. 3 is a diagrammatical illustration of a premixing device 60 having an exemplary configuration of the swirler vanes such as represented by reference numeral 62 employed in the combustor 40 of FIG. 2 in accordance with aspects of the present technique. The premixing device 62 receives the compressed air 18 from the compressor 14. Further, in this example, the premixing device 62 receives fuel 20 through fuel holes such as represented by reference numerals 64 and 66 disposed on the plurality of swirler vanes 62. In certain embodiments, the fuel 20 may be introduced into the nozzle in other configurations. Examples of fuel 20 comprise hydrocarbon fuels, or a syngas fuel, or carbon monoxide, or a mixture of hydrocarbon fuels, or a fuel with hydrogen content, or a fuel with carbon monoxide, or a fuel with inert content, or combinations thereof.

In the illustrated embodiment, a shape of the plurality of swirler vanes 62 is selected such that the vanes 62 provide relatively low swirl to the fuel 20 and/or air 18 near a centerbody of the premixing device 60. In one exemplary embodiment, a swirl angle of each of the plurality of swirler vanes 62 is adjusted to control the axial velocity profile of the fuel 20 and/or air 18 within the premixing device. In certain embodiments, the swirl angle of each of the plurality of swirler vanes 62 is about 0 degrees to about 60 degrees. In one exemplary embodiment, the swirl angle of each of the plurality of swirler vanes 62 is about 20 degrees.

Further, the plurality of swirler vanes 62 may include different swirl angles. As described above, the shape of the plurality of swirler vanes 62 is selected such that the vanes 62 provide relatively low swirl to the fuel 20/air 18 mixture near a centerbody of the premixing device 60. In particular, such configuration of the swirler vanes 62 facilitates enhancement of the fuel-air mixing and a flame holding margin of the premixing device. Further, the shape of the swirler vanes 62 is selected such that it enhances the flash back resistance of the device 60 while reducing a pressure drop across the premixing device 60.

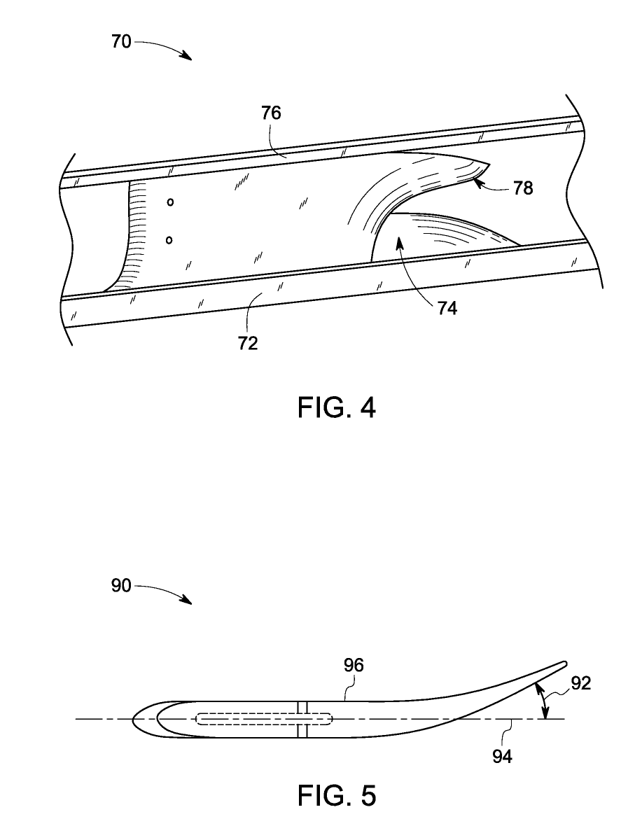

FIG. 4 is a diagrammatical illustration of an exemplary configuration 70 of the swirler vanes 62 of FIG. 3 in accordance with aspects of the present technique. In the illustrated embodiment, the shape of the swirler vane 62 is selected to provide relatively low swirl to the fuel 20 (see FIG. 2) and/or air 18 (see FIG. 2) near a centerbody 72 of the premixing device 60 (see FIG. 3) to form a low swirl region 74. In addition, the shape of the swirler vane 62 is selected to provide relatively high swirl to the fuel 20 and/or air 18 near a shroud 76 of the premixing device 60 to form a high swirl region 78. Advantageously, the high swirl near the shroud 76 where most of the fuel 20 and air 18 flows through enhances the fuel-air mixing. Further, the low swirl near the centerbody 72 reduces the burner tube pressure loss for the premixing device 60.

It should be noted that, a plurality of shapes and sizes of the swirler vanes may be selected to form the low and high swirl regions 74 and 78 respectively. For example, a swirl angle of each of the swirler vans 62 may be adjusted to control the axial and circumferential velocity profiles of the fuel 20 and/or air 18 within the premixing device 60. FIG. 5 is a diagrammatical illustration of another exemplary configuration 90 of the swirler vanes 70 of FIG. 4 in accordance with aspects of the present technique. In this exemplary embodiment, a swirl angle 92 with respect to a centerline 94 of the swirler vane 96 is adjusted to achieve a desired axial and circumferential velocity profile of the fuel 20 and/or air 18 within the premixing device 60. In certain embodiments, the swirl angle 92 is about 0 degrees to about 60 degrees. In one exemplary embodiment, the swirl angle 92 is about 20 degrees. Further, the plurality of swirler vanes 62 (see FIG. 3) may each have different swirl angles 92.

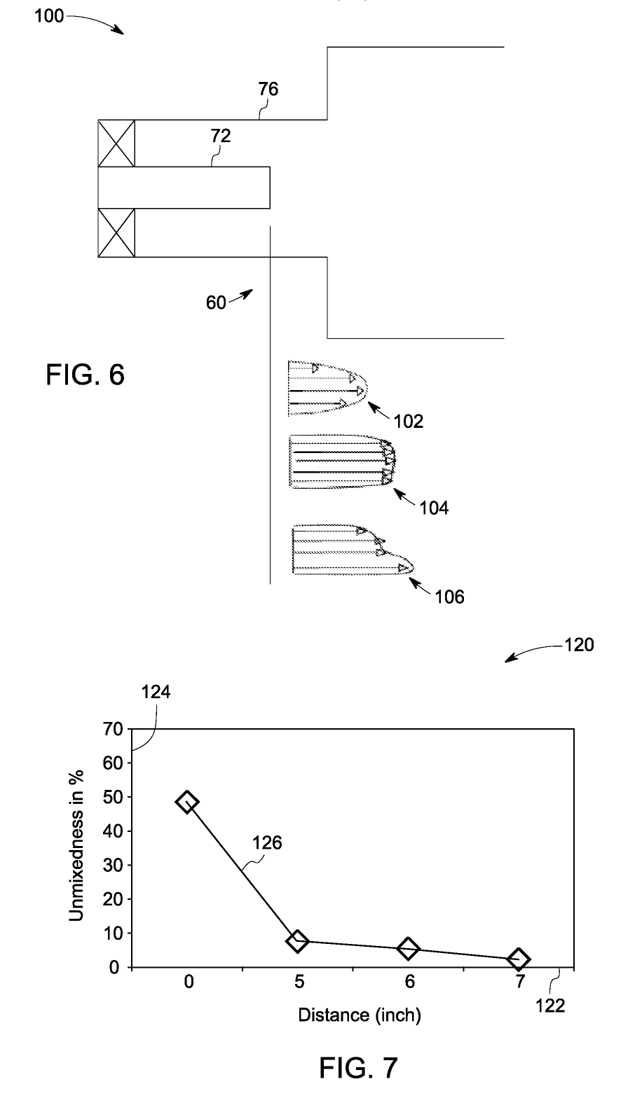

FIG. 6 is a diagrammatical illustration of exemplary axial velocity profile 100 across the annulus at the end of the centerbody of the premixing device 42 employed in the combustor 40 of FIG. 2 in accordance with aspects of the present technique. In this exemplary embodiment, profile 102 represents an exemplary axial velocity profile of a contemporary swirler without customizing the swirler vanes 50 (see FIG. 2) of the premixing device 42. Further, profile 104 represents an exemplary axial velocity profile with swirler vanes 50 having a relatively low swirl angle 92 (see FIG. 5) for reducing the swirl for the fuel 20 and/or air 18 (see FIG. 2). Additionally, the profile 106 represents an exemplary axial velocity profile with swirler vanes 50 for maintaining relatively low swirl to the fuel 20 and/or air 18 near the centerbody 72 of the premixing device 60 and a relatively high swirl to the fuel 20 and/or air 18 near the shroud 76 of the premixing device 60. Advantageously, such configuration enhances the fuel-air mixing and reduces the pressure drop within the premixing device 60. Further, it increases the flameholding margin and also enhances the flame flash back resistance. FIGS. 7-9 illustrate exemplary results for fuel/air unmixedness for premixing device with conventional swirl vanes, with a low swirl and with the customized swirler respectively.

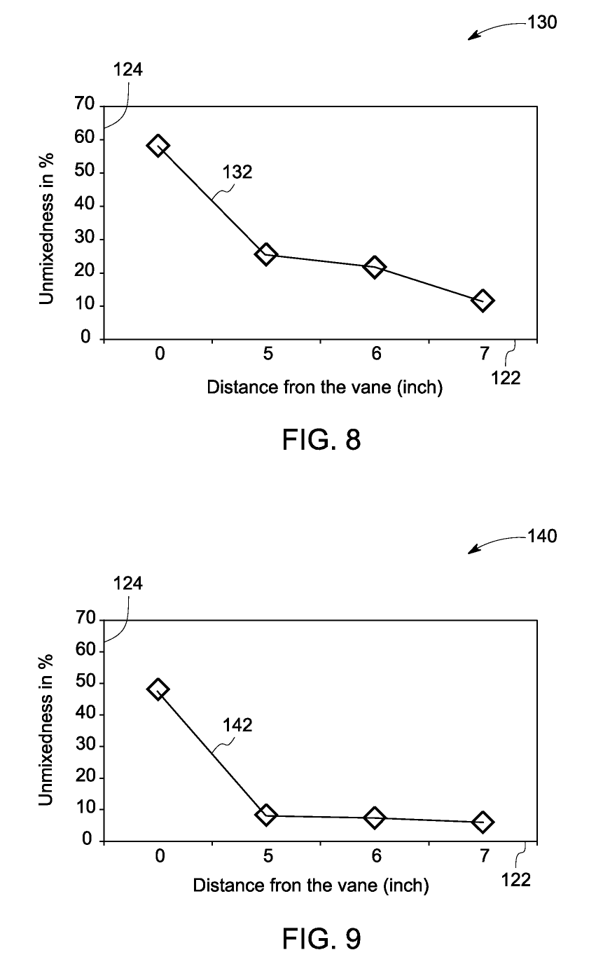

FIG. 7 is a graphical representation of exemplary results 120 for fuel 20/air 18 unmixedness for a premixing device using a conventional swirler. The abscissa axis 122 represents a distance from the vane of the premixing device and the ordinate axis 124 represents the percentage 124 of the fuel 20/air 18 unmixedness. In this exemplary embodiment, profile 126 represents the fuel 20/air 18 unmixedness at different axial locations downstream of the fuel 20 injection. FIG. 8 is a graphical representation of exemplary results 130 for fuel 20/air 18 unmixedness for a premixing device with a low swirl. In this exemplary embodiment, profile 132 represents the fuel 20/air 18 unmixedness at different axial locations downstream of the fuel 20 injection for a low swirl condition. In the illustrated embodiment, the swirl angle of the vanes is about 20 degrees.

FIG. 9 is a graphical representation of exemplary results 140 for fuel/air unmixedness for the premixing device 70 of FIG. 4. In this exemplary embodiment, profile 142 represents the fuel 20/air 18 unmixedness at different axial locations downstream of the fuel 20 injection for a customized swirl condition. In this embodiment, the shape and size of the vanes 62 is selected to provide relatively low swirl to the fuel 20 and/or air 18 near the centerbody 72 (see FIG. 4) and to provide relatively high swirl to the fuel 20 and/or air 18 near the shroud 76 (see FIG. 4). In this embodiment, the fuel 20/air 18 mixedness with the vane design for customized swirl maintains a high valve of about 87% as compared to 93% for the premixing device with conventional swirl and about 74% for the premixing device with a low swirl. Further, the overall burner tube pressure drop using the vane design of FIG. 4 is reduced by about 40% as compared to the premixing device with a conventional swirler.

The various aspects of the method described hereinabove have utility in different applications such as combustors employed in gas turbines. As noted above, the tailoring of the axial and circumferential velocity profile achieved in a premixing device using the swirler design described above facilitates enhancement of the flame holding margin, but without deteriorating the fuel air mixing of the premixing device. Further, the shape of the swirler vanes is selected such that it enhances the flash back resistance of the device while reducing the pressure drop across the premixing device. In addition, the premixing device described above may be employed for a wide range of fuels thus providing enhanced fuel flexibility of the system.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A premixing device, comprising:
a fuel inlet configured to introduce a fuel within the premixing device;
an air inlet configured to introduce air within the premixing device; and
a plurality of swirler vanes configured to provide a swirl movement to the fuel and/or air to facilitate mixing of the fuel and air to form a gaseous pre-mix, wherein a shape of each of the plurality of swirler vanes is selected to control an axial velocity profile of the fuel and/or air within the premixing device.

2. The premixing device of claim 1, wherein the shape of each of the plurality of swirler vanes is selected such that the vanes provide relatively high swirl to the fuel and/or air near a shroud of the premixing device.

3. The premixing device of claim 2, wherein the shape of each of the plurality of swirler vanes is selected such that the vanes provide relatively low swirl to the fuel and/or air near a centerbody of the premixing device.

4. The premixing device of claim 1, wherein a swirl angle of each of the plurality of vanes is adjusted to control the axial velocity profile of the fuel and/or air within the premixing device.

5. The premixing device of claim 4, wherein the swirl angle of each of the plurality of vanes is about 0 degrees to about 60 degrees.

6. The premixing device of claim 5, wherein the swirl angle of each of the plurality of vanes is about 0 to 20 degrees.

7. The premixing device of claim 4, wherein the plurality of swirl vanes comprise different swirl angles.

8. The premixing device of claim 2, wherein the shape of each of the plurality of swirler vanes is configured to enhance fuel-air mixing and flame holding margin of the premixing device.

9. The premixing device of claim 8, wherein the shape of each of the plurality of swirler vanes is further configured to enhance flash back resistance of the premixing device.

10. The premixing device of claim 8, wherein the shape of each of the plurality of swirler vanes is further configured to reduce a pressure drop across the premixing device.

11. The premixing device of claim 1, wherein the fuel comprises a hydrocarbon fuel, or a syngas fuel, or carbon monoxide, or a mixture of hydrocarbon fuels, or a fuel with hydrogen content, or a fuel with carbon monoxide, or a fuel with inert content, or combinations thereof.

12. The premixing device of claim 1, wherein the shape of each of the plurality of swirler vanes is selected to control a circumferential velocity profile, or a radial velocity profile, or combinations thereof of the fuel and/or air within the premixing device.

13. A combustor, comprising:
a premixing device configured to mix fuel and air to form a gaseous pre-mix, wherein the premixing device comprises:
a plurality of swirler vanes configured to provide a swirl movement to the fuel and/or air to facilitate mixing of the fuel and air, wherein a shape of each of the plurality of swirler vanes is selected to control an axial velocity profile of the fuel and/or air within the premixing device; and
a combustion chamber configured to combust the gaseous pre-mix.

14. The combustor of claim 13, wherein the shape of each of the plurality of swirler vanes is selected such that the vanes provide relatively high swirl to the fuel and/or air near a shroud of the premixing device and to provide relatively low swirl to the fuel and/or air near a centerbody of the premixing device.

15. The combustor of claim 13, wherein a swirl angle of each of the plurality of vanes is adjusted to control the axial velocity profile of the fuel and/or air within the premixing device.

16. The combustor of claim 13, wherein the fuel comprises a hydrocarbon fuel, or a syngas fuel, or carbon monoxide, or a mixture of hydrocarbon fuels, or a fuel with hydrogen content, or a fuel with carbon monoxide, or a fuel with inert content, or combinations thereof.

17. A method of operating a combustor; comprising:
introducing fuel and air within a premixing device;
controlling an axial velocity profile of the fuel and/or air within the premixing device to form a gaseous pre-mix; and
combusting the gaseous pre-mix in a combustion chamber.

18. The method of claim 17, wherein controlling an axial velocity profile comprises customizing swirling of the fuel and/or air within the premixing device.

19. The method of claim 18, wherein customizing swirling of the fuel and/or air comprises providing relatively high swirl to the fuel and/or air near a shroud of the premixing device and relatively low swirl to the fuel and/or air near a centerbody of the premixing device.

20. The method of claim 19, wherein customizing swirling of the fuel comprises providing swirl of the fuel and/or air using a plurality of swirler vanes having different shapes and sizes

21. The method of claim 20, further comprising selecting the shape of the plurality of swirler vanes for enhancing fuel-air mixing and flame holding margin of the premixing device.

22. The method of claim 20, further comprising selecting the shape of the plurality of swirler vanes for enhancing flash back resistance of the premixing device.

23. The method of claim 20, further comprising selecting the shape of the plurality of swirler vanes for reducing a pressure drop across the premixing device.

24. The method of claim 20, further comprising selecting the shape of the plurality of swirler vanes for tailoring a fuel-air distribution in the premixing device.

25. The method of claim 24, further comprising selecting the shape of the plurality of swirler vanes for substantially reducing combustion instabilities in the combustion chamber.
